(19) United States
(12) Patent Application Publication
(10) Pub. No.: US 2024/0373473 A1
(43) Pub. Date: Nov. 7, 2024

(54) METHOD FOR INFORMATION PROCESSING AND TERMINAL DEVICE

(71) Applicant: GUANGDONG OPPO MOBILE TELECOMMUNICATIONS CORP., LTD., Dongguan (CN)

(72) Inventor: Chuanfeng HE, Dongguan (CN)

(21) Appl. No.: 18/773,543

(22) Filed: Jul. 15, 2024

Related U.S. Application Data
(63) Continuation of application No. PCT/CN2022/072402, filed on Jan. 17, 2022.

(51) Int. Cl. H04W 74/0833; H04W 74/08

(52) U.S. Cl. CPC H04W 74/0833; H04W 74/0891

(57) ABSTRACT

A method for information processing and a terminal device is provided. The method includes the following. The terminal device determines related information of an association period between physical random access channel (PRACH) occasions and synchronization signal/physical broadcast channel blocks (SS/PBCH blocks, SSBs) according to the number of PRACH repetitions.

### CROSS REFERENCE TO RELATED APPLICATION(S)

This application is a continuation of International Application No. PCT/CN2022/072402, filed Jan. 17, 2022, the entire disclosure of which is incorporated herein by reference.

### TECHNICAL FIELD

This disclosure relates to the field of communication, and more particularly, to a method for information processing, a terminal device, a network device, a chip, a computer-readable storage medium, a computer program product, a computer program, and a communication system.

### BACKGROUND

Random access is a procedure that is necessary for wireless link establishment between a terminal and a network. Generally speaking, the terminal may determine, according to an indication from the network, a resource configuration for random access and an association between synchronization signal/physical broadcast channel blocks (SS/PBCH blocks, SSBs) and random access resources, thereby determining an available random access resource according to an SSB detected and the association.

In some communication scenarios, in order to improve coverage performance, introduction of physical random access channel (PRACH) repetitions can be taken into consideration. However, realization of PRACH repetitions cannot be ensured if a mechanism for associating SSBs with random access resources in the related art is adopted.

### SUMMARY

Embodiments of the disclosure provide a method for information processing. The method includes the following. The terminal device determines related information of an association period between physical random access channel (PRACH) occasions and synchronization signal/physical broadcast channel blocks (SS/PBCH blocks, SSBs) according to the number of PRACH repetitions.

Embodiments of the disclosure provide a method for information processing. The method includes the following. A network device sends indication information of a PRACH resource to a terminal device, where the PRACH resource includes PRACH occasions for PRACH repetitions, and related information of an association period between PRACH occasions and SSBs is determined according to the number of PRACH repetitions.

Embodiments of the disclosure further provide a terminal device. The terminal device includes a processor and a memory. The memory is configured to store computer programs. The processor is configured to invoke and execute the computer programs stored in the memory, to determine related information of an association period between PRACH occasions and SSBs according to the number of PRACH repetitions.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF THE DRAWINGS

FIG. 1 is a schematic architectural diagram of a communication system according to embodiments of the disclosure.

FIG. 2 is a schematic diagram illustrating a synchronization signal/physical broadcast channel block (SS/PBCH block, SSB) according to embodiments of the disclosure.

FIG. 3 is a schematic diagram illustrating a frequency-domain resource location of a random access channel (RACH) resource according to embodiments of the disclosure.

FIG. 4 is a schematic diagram illustrating a mapping between SSBs and physical RACH (PRACH) occasions according to an embodiment of the disclosure.

FIG. 5 is a schematic flowchart of a method for information processing according to an embodiment of the disclosure.

FIG. 6 is a schematic flowchart of a method for information processing according to another embodiment of the disclosure.

FIG. 7 is a diagram illustrating an association period between SSBs and PRACH occasions according to an embodiment of the disclosure.

FIG. 8 is a diagram illustrating an association period between SSBs and PRACH occasions according to another embodiment of the disclosure.

FIG. 9 is a diagram illustrating an association period between SSBs and PRACH occasions according to another embodiment of the disclosure.

FIG. 10 is a schematic diagram illustrating determination of a location of an association period set according to an embodiment of the disclosure.

FIG. 11 is a diagram illustrating PRACH occasions for PRACH repetitions according to an embodiment of the disclosure.

FIG. 12 is a schematic structural block diagram of a terminal device according to an embodiment of the disclosure.

FIG. 13 is a schematic structural block diagram of a terminal device according to another embodiment of the disclosure.

FIG. 14 is a schematic structural block diagram of a terminal device according to another embodiment of the disclosure.

FIG. 15 is a schematic structural block diagram of a network device according to an embodiment of the disclosure.

FIG. 16 is a schematic structural block diagram of a network device according to another embodiment of the disclosure.

FIG. 17 is a schematic block diagram of a communication device according to embodiments of the disclosure.

FIG. 18 is a schematic block diagram of a chip according to embodiments of the disclosure.

FIG. 19 is a schematic block diagram of a communication system according to embodiments of the disclosure.

### DETAILED DESCRIPTION

The following will describe technical solutions of embodiments of the disclosure with reference to the accompanying drawings in embodiments of the disclosure.

The technical solutions of embodiments of the disclosure are applicable to various communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (WiFi), a 5^{th}-generation (5G) communication system, or other communication systems, etc.

Generally speaking, a conventional communication system generally supports a limited quantity of connections and therefore is easy to implement. However, with development of communication technology, a mobile communication system will not only support conventional communication but also support, for example, device to device (D2D) communication, machine to machine (M2M) communication, machine type communication (MTC), vehicle to vehicle (V2V) communication, or vehicle to everything (V2X) communication, etc. Embodiments of the disclosure can also be applied to these communication systems.

In an embodiment, the communication system in embodiments of the disclosure may be applied to a carrier aggregation (CA) scenario, or may be applied to a dual connectivity (DC) scenario, or may be applied to a standalone (SA) network deployment scenario.

Various embodiments of the disclosure are described in connection with a network device and a terminal device. The terminal device may also be referred to as a user equipment (UE), an access terminal, a subscriber unit, a subscriber station, a mobile station, a remote station, a remote terminal, a mobile device, a user terminal, a terminal, a wireless communication device, a user agent, or a user device, etc.

The terminal device may be a station (ST) in a WLAN, a cellular radio telephone, a cordless telephone, a session initiation protocol (SIP) telephone, a wireless local loop (WLL) station, a personal digital assistant (PDA), various devices with wireless communication functions such as a handheld device or a computing device, other processing devices coupled with a wireless modem, an in-vehicle device, a wearable device, and a terminal device in a next-generation communication system, for example, a terminal device in an NR network, or a terminal device in a future evolved public land mobile network (PLMN), etc.

In embodiments of the disclosure, the terminal device may be deployed on land, which includes indoor or outdoor, handheld, wearable, or in-vehicle. The terminal device may also be deployed on water (such as ships, etc.). The terminal device may also be deployed in the air (such as airplanes, balloons, satellites, etc.).

In embodiments of the disclosure, the terminal device may be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city, or a wireless terminal device in smart home, etc.

By way of explanation rather than limitation, in embodiments of the disclosure, the terminal device may also be a wearable device. The wearable device may also be called a wearable smart device, which is a generic term of wearable devices obtained through intelligent design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

In embodiments of the disclosure, the network device may be a device configured to communicate with a mobile device, and the network device may be an access point (AP) in a WLAN, a base transceiver station (BTS) in GSM or CDMA, or may be a Node B (NB) in WCDMA, or may be an evolutional Node B (eNB or eNodeB) in LTE, or a relay station or AP, or an in-vehicle device, a wearable device, a network device (gNB) in an NR network, or a network device in a future evolved PLMN, etc.

The network device may also be a core network device, for example, a mobility management entity (MME), an access and mobility management function (AMF), and other network entities. Embodiments of the disclosure are not limited in this regard.

By way of explanation rather than limitation, in embodiments of the disclosure, the network device may be mobile. For example, the network device may be a mobile device. In an embodiment, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. In an embodiment, the network device may also be a base station deployed on land or water.

In embodiments of the disclosure, the network device serves a cell, and the terminal device communicates with the network device on a transmission resource (for example, a frequency-domain resource or a spectrum resource) for the cell. The cell may be a cell corresponding to the network device (for example, a base station). The cell may belong to a macro base station, or may belong to a base station corresponding to a small cell. The small cell may include: a metro cell, a micro cell, a pico cell, a femto cell, and the like. These small cells are characterized by small coverage and low transmission power and are adapted to provide data transmission service with high-rate.

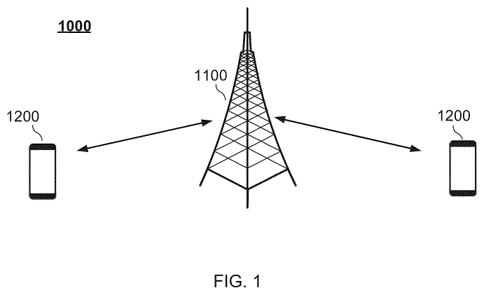

FIG. 1 schematically illustrates a wireless access system 1000 that includes one network device 1100 and two terminal devices 1200. In an embodiment, the wireless communication system 1000 may include multiple network devices 1100, and there may be other quantities of terminal devices in a coverage area of each of the network devices 1100.

It should be understood that, in embodiments of the disclosure, a device with communication functions in a network/system can be referred to as a “communication device”. Taking the communication system illustrated in FIG. 1 as an example, the communication device may include a network device and a terminal device that have communication functions. The network device and the terminal device can be the devices in embodiments of the disclosure.

It should be understood that, the terms “system” and “network” herein are usually used interchangeably throughout this disclosure. The term “and/or” herein only describes an association between associated objects, which means that there can be three relationships. For example, A and/or B can mean A alone, both A and B exist, and B alone. In addition, the character “/” herein generally indicates that the associated objects are in an “or” relationship.

It should be understood that, “indication” referred to in embodiments of the disclosure may be a direct indication, may be an indirect indication, or may mean that there is an association. For example, A indicates B may mean that A directly indicates B, for instance, B can be obtained according to A; may mean that A indirectly indicates B, for instance, A indicates C, and B can be obtained according to C; or may mean that that there is an association between A and B.

In the elaboration of embodiments of the disclosure, the term “correspondence” may mean that there is a direct or indirect correspondence between the two, may mean that there is an association between the two, or may mean a relationship of indicating and indicated or configuring and configured, etc.

In order for better understanding of the technical solutions of embodiments of the disclosure, the following will describe the related art of embodiments of the disclosure. The following related art as an optional solution may be arbitrarily combined with the technical solutions of embodiments of the disclosure, and shall all belong to the protection scope of embodiments of the disclosure.

### (I) Synchronization Signal/Physical Broadcast Channel Block (SS/PBCH Block, SSB) in NR

In an NR system, for a common channel such as a broadcast channel and a signal such as an SS, beam sweeping is needed for covering a whole cell, so as to facilitate reception by a UE in the cell. SS multi-beam transmission is implemented by defining an SS/PBCH burst set. Each SS/PBCH burst set includes one or more SSBs. Each SSB is used for carrying an SS and a broadcast channel of one beam. Therefore, each SS/PBCH burst set may include SSs of one or more beams in a cell, where the number of beams is determined according to a parameter SS block number. The maximum value L of SS block number depends on a frequency band of a system: for a frequency range up to 3 gigahertz (GHz), L=4; for a frequency range from 3 GHz to 6 GHz, L=8; and for a frequency range from 6 GHz to 52.6 GHz, L=64.

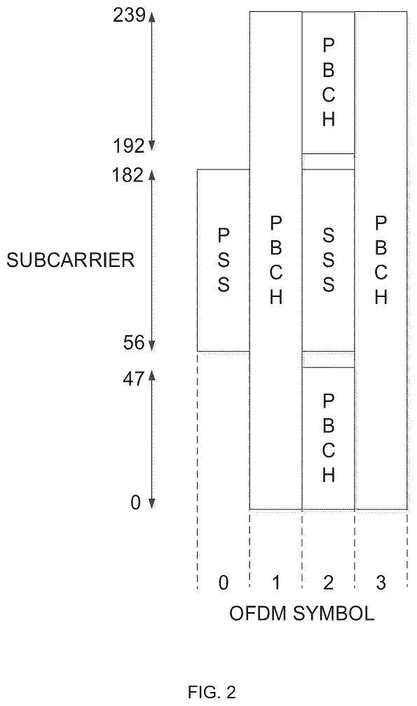

An SSB consists of a primary SS (PSS) occupying one symbol, a secondary SS (SSS) occupying one symbol, and a PBCH occupying two symbols, as illustrated in FIG. 2. A time-frequency resource occupied by a PBCH contains a demodulation reference signal (DMRS) that is used for demodulation of the PBCH.

All SSBs in an SS/PBCH burst set are sent within a 5-millisecond (ms) time window and are sent repeatedly with a certain period, where the period is configured via a higher-layer parameter SSB-timing and includes 5 ms, 10 ms, 20 ms, 40 ms, 80 ms, and 160 ms, etc. According to an SSB received, the UE may obtain an index of the SSB (i. e. SSB index). A value range of an SSB index is [0, L˜1], where L is the maximum number of SSBs corresponding to a frequency band in which the SSB is located. The SSB index corresponds to a relative location of the SSB within the 5 ms time window, and the UE obtains frame synchronization according to the information and a half-frame indication carried on a PBCH. The SSB index is indicated by a DMRS for the PBCH or information carried on the PBCH.

In addition to an SS and a PBCH, for some other common information such as system information block 1 (SIB1) and paging, beam sweeping is also needed for transmission.

### (II) Random Access Channel (RACH) Procedure

In NR technology, a RACH resource configured for an accessing UE is defined, which includes 256 configurations. RACH resource configuration information used for a cell is indicated to the accessing UE in a system message. Each RACH resource configuration includes a preamble format, a period, a radio frame offset, a subframe number (that is, index) within a radio frame, a starting symbol within a subframe, the number of PRACH slots within a subframe, the number of PRACH occasions within a PRACH slot, and a PRACH duration. Time information, frequency information, and code information of a PRACH resource can be determined according to the information indicated. As shown in table 1 below, a PRACH configuration index is 86 (PRACH Configuration Index=86), which indicates a preamble format, a radio frame, a subframe, a starting symbol, and a duration of a PRACH occasion, etc.

TABLE 1
Example of RACH resource

| | | | | | | | Nₜ^{RA, slot}, | |
|---|---|---|---|---|---|---|---|---|
| | | | | | | | number | |
| | | | | | | Number | of PRACH | |
| | | | | | | of PRACH | occasions | |
| PRACH | | n_{SFN} mod | | | | slots | within a | N_{dur}^{RA}, |
| configuration | Preamble | x = y | | Subframe | Starting | within a | PRACH | PRACH |
| index | format | x | y | number | symbol | subframe | slot | duration |
| 86 | A1 | 1 | 0 | 0, 1, 2, 3, | 7 | 1 | 3 | 2 |
| | | | | 4, 5, 6, 7, | | | | |
| | | | | 8, 9 | | | | |

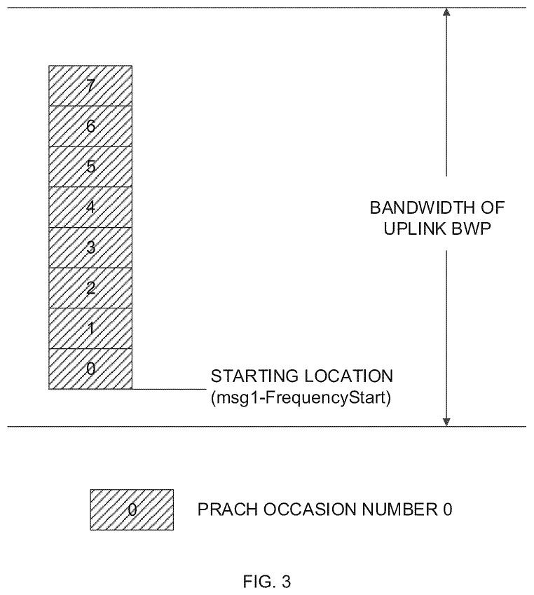

In addition to a time-domain resource location of a RACH resource, a frequency-domain resource location of a RACH resource is indicated by a parameter msg1-FrequencyStart and a parameter msg1-FDMin higher-layer signaling RACH-ConfigGeneric. As illustrated in FIG. 3, the parameter msg1-FrequencyStart is used for determining an offset of a starting resource block (RB) location of a PRACH occasion with number (i.e. index) 0 (PRACH occasion 0) relative to a frequency-domain starting location of an uplink common bandwidth part (BWP) (namely, BWP 0), that is, to determine a frequency-domain starting location of a RACH resource. The value of the parameter msg1-FDM is {1,2,4,8}, which is used for determining the number of frequency-domain PRACH occasions. In the example illustrated in FIG. 3, msg1-FDM=8.

For the UE, besides a RACH resource configuration indicated by a system message, an association between SSBs and PRACH resources is also indicated, so that the UE can determine a RACH resource available for the UE according to an SSB detected and the association. Each SSB is associated with one or more PRACH occasions, and is also associated with multiple contention based preambles. That is, each SSB index is associated with some specific resource(s) in the RACH resource configuration indicated by the system message.

Via a parameter ssb-perRACH-OccasionAndCB-PreamblesPerSSB, an upper layer configures N (ssb-perRACH-Occasion) SSBs associated with each PRACH occasion, and configures the number of contention based preambles per SSB per valid PRACH occasion (CB-PreamblesPerSSB).

If N<1, each SSB is mapped to 1/N consecutive valid PRACH occasions, for example, if N=¼, each SSB is mapped to four PRACH occasions. R (CB-PreamblesPerSSB) preambles with consecutive indexes associated with SSB n per valid PRACH occasion start from preamble index 0, where 0<=n<=N−1.

If N>=1, R preambles with consecutive indexes associated with SSB n per valid PRACH occasion start from preamble index n·N_{preamble}^{total}/N, where 0<=n<=N−1. For example, if N=2 and N_{preamble}^{total}=64, two SSBs are mapped to one PRACH occasion. In this case, for the two SSBs n, n=0,1. If n=0, an index of a preamble associated with SSB 0 starts from 0; if n=1, an index of a preamble associated with SSB 1 starts from 32. The index of the preamble associated with SSB 0 is 0˜ 31, and the index of the preamble associated with SSB 1 is 32˜ the number of contention based preambles configured˜1. A valid PRACH occasion corresponds to the total number of contention based preambles, and in this case, each valid PRACH occasion corresponds to two SSBs and thus, the two SSBs each occupy some of the preambles (different from the case where N<1). N_{preamble}^{total} is configured via a parameter totalNumberOfRA-Preambles, and is an integer multiple of N.

SSBs are mapped to PRACH occasions in the following order: first, in an increasing order of preamble indexes within a single PRACH occasion; second, in an increasing order of frequency resource indexes for frequency multiplexed PRACH occasions; third, in an increasing order of time resource indexes for time multiplexed PRACH occasions within a PRACH slot; fourth, in an increasing order of indexes for PRACH slots.

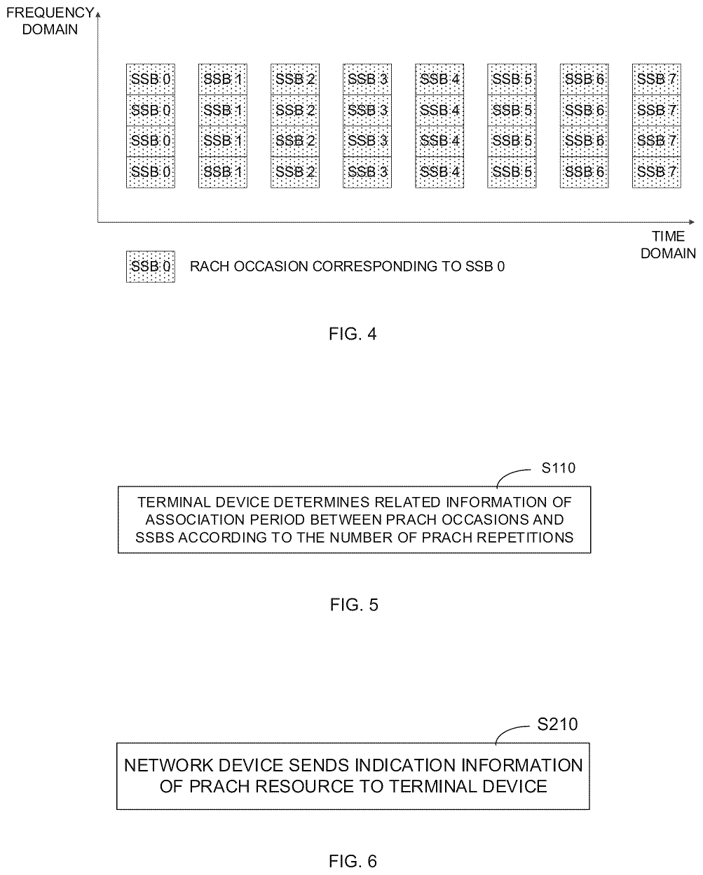

For example, if the number of SSBs is 8 (indexed 0˜ 7), msg1-FDM=4 (indicating that the number of frequency-domain PRACH occasions is four), and ssb-perRACH-Occasion=¼ (indicating that each SSB is mapped to four PRACH occasions), a mapping between SSBs and PRACH occasions is that as illustrated in FIG. 4.

### (III) PRACH Repetitions in a Machine Type Communication (MTC) System

In an MTC system, uplink coverage enhancement is realized for an MTC terminal, and repetitions are supported for PRACH transmission. A network configures at most four RACH configuration parameter sets for the MTC terminal, which correspond to four coverage levels respectively. The MTC terminal determines a coverage level for the MTC terminal according to a reference signal received power (RSRP) measured and a threshold configured by the network, and selects a RACH configuration parameter(s) corresponding to the coverage level. The RACH configuration parameter includes a PRACH frequency offset, the number of PRACH repetitions, a starting subframe for PRACH repetitions, a frequency-hopping parameter for a PRACH frequency-domain resource, etc.

A subframe set in which a PRACH resource is located may be obtained according to a time-domain resource of the RACH resource configured by an upper layer. A starting subframe for PRACH transmission in the subframe set in which the PRACH resource is located is determined according to the number of PRACH repetitions and the starting subframe for PRACH repetitions in the RACH configuration parameter. If the MTC terminal needs to initiate a RACH procedure, the MTC terminal starts PRACH repetitions from a starting subframe that is closest in time.

However, a RACH procedure in an NR system does not support PRACH repetitions, and there is a mapping between RACH resources and SSBs. If uplink coverage enhancement is taken into consideration by introducing PRACH repetitions in an NR-light system, a mapping between PRACH repetitions, SSBs, and PRACH occasions needs to be taken into consideration, so as to ensure realization of PRACH repetitions.

Specifically, in the related art, SSBs are mapped to PRACH occasions within each association period. N_{TX}^{SSB} SSBs each are mapped at least once to a PRACH occasion configured by the network within each association period, that is, each of the N_{TX}^{SSB} SSBs needs to be mapped to at least one PRACH occasion. N_{TX}^{SSB} is the number of SSBs actually transmitted, and the value thereof is obtained according to a parameter ssb-PositionsInBurst in SIB1 or according to signaling ServingCellConfigCommon.

The association period is an integer multiple of a PRACH configuration period, and the value range of the integer is that as shown in Table 2. The value of the association period is the smallest value in a value range of the integer multiple of the PRACH configuration period which satisfies that the N_{TX}^{SSB} SSBs each are mapped at least once to the PRACH occasion configured by the network.

TABLE 2
Value range of association period

| PRACH configuration period | Association period (multiple of PRACH |
|---|---|
| (ms) | configuration period) |
| 10 | {1, 2, 4, 8, 16} |
| 20 | {1, 2, 4, 8} |
| 40 | {1, 2, 4} |
| 80 | {1, 2} |
| 160 | {1} |

For the case of PRACH repetitions, after determining a target SSB, a UE needs to select a PRACH resource associated with the SSB to initiate random access. In order to realize PRACH repetitions, it is necessary to select multiple PRACH occasions associated with the target SSB to implement PRACH repetitions, where the multiple PRACH occasions are PRACH occasions that are different in time domain. In addition, since each SSB is associated at least once with a PRACH occasion within each association period, the UE can find at least one PRACH occasion within the association period to perform PRACH transmission. However, some of the PRACH occasions are likely not to be associated with an SSB within the association period. After mapping of all SSBs to PRACH occasions is completed, the remaining PRACH resources not associated with the SSBs cannot be used for PRACH transmission, which causes waste of PRACH resources. The solutions provided in embodiments of the disclosure is mainly intended for solving at least one of the above problems. For the case of PRACH repetitions, each SSB can be associated at least with multiple PRACH occasions within each association period between SSBs and PRACH occasions, thereby realizing full utilization of PRACH resources.

In order for better understanding of features and technical content of embodiments of the disclosure, the implementation of embodiments of the disclosure will be described in detail below with reference to the accompanying drawings. The accompanying drawings are only intended for illustration and are not intended to limit embodiments of the disclosure.

FIG. 5 is a schematic flowchart of a method for information processing according to an embodiment of the disclosure. The method may In an embodiment be applied to the system illustrated in FIG. 1, but is not limited thereto. The method includes the following.

S110, a terminal device determines related information of an association period between PRACH occasions and SSBs according to the number of PRACH repetitions.

In an embodiment, the related information of the association period includes a size of the association period and/or the number of association periods corresponding to PRACH repetitions.

Exemplarily, if the number of PRACH repetitions configured by a network is K, the size of the association period between SSBs and PRACH occasions is determined according to K. For example, the size of the association period which satisfies that each SSB can be associated with K PRACH occasions is determined, so that PRACH repetitions can be implemented in the K PRACH occasions. Alternatively, the terminal device may determine, according to K, the number M of association periods corresponding to PRACH repetitions, where the M association periods satisfy requirements that each SSB can be associated with the K PRACH occasions. K and M each are an integer, K≥1, and M≥1.

The PRACH occasion may be determined according to an indication of a network device. Specifically, embodiments of the disclosure further provide a method for information processing. As illustrated in FIG. 6, the method includes the following.

S210, a network device sends indication information of a PRACH resource to a terminal device.

The PRACH resource includes PRACH occasions for PRACH repetitions, and related information of an association period between PRACH occasions and SSBs is determined according to the number of PRACH repetitions.

In an embodiment, the size of the association period is determined from at least one multiple of a PRACH configuration period according to the number of PRACH repetitions. Accordingly, the terminal device determines the related information of the association period between PRACH occasions and SSBs according to the number of PRACH repetitions in step S110 as follows. The terminal device determines the size of the association period from the at least one multiple of the PRACH configuration period according to the number of PRACH repetitions.

That is, the terminal device may select one multiple from the at least one multiple of the PRACH configuration period as the size of the association period, for example, two times or four times of the PRACH configuration period. The size of the PRACH configuration period and a candidate multiple(s) of the PRACH configuration period may be set with reference to table 2. For example, if the PRACH configuration period is 20 ms, the at least one multiple of the PRACH configuration period includes one time, two times, four times, and eight times of 20 ms.

In an embodiment, the size of the association period is the smallest value in the at least one multiple that satisfies a predefined condition, where the predefined condition relates to the number of PRACH repetitions. Accordingly, the terminal device may determine the size of the association period from the at least one multiple of the PRACH configuration period according to the number of PRACH repetitions as follows. The terminal device determines the smallest value in the at least one multiple that satisfies the predefined condition as the size of the association period, where the predefined condition relates to the number of PRACH repetitions.

For example, a condition is set based on the number of PRACH repetitions. If two times, four times, and eight times of the PRACH configuration period each satisfy the condition, two times of the PRACH configuration period is determined as the size of the association period, so as to realize full utilization of PRACH resources.

Exemplarily, the predefined condition includes: each SSB transmitted by the network device can be mapped to at least N PRACH occasions within a time-domain window corresponding to the multiple, where N depends on the number of PRACH repetitions, and N is an integer and N≥1.

For example, if the PRACH configuration period is 80 ms and the candidate multiple of the PRACH configuration period is one time and two times, a time-domain window corresponding to one time of the PRACH configuration period is a 80 ms time-domain window, and a time-domain window corresponding to two times of the PRACH configuration period is a 160 ms time-domain window. If each SSB transmitted by the network device can be mapped to at least N PRACH occasions within any one of a 80 ms time-domain window and a 160 ms time-domain window, 80 ms may be used as the size of the association period.

Exemplarily, each SSB transmitted by the network device is, for example, each of the foregoing SSBs, where the value of is obtained according to a parameter ssb-PositionsInBurst in SIB1 or according to signaling ServingCellConfigCommon.

In an embodiment, N may be less than or equal to the number of PRACH repetitions, so as to fully utilize PRACH resources.

Exemplarily, N may be equal to the number of PRACH repetitions. For example, if the number of PRACH repetitions is two, N=2. The terminal device can complete two PRACH repetitions within each association period.

Exemplarily, N may be less than the number of PRACH repetitions. For example, the number of repetitions is K, and mapping of each SSB transmitted by the network to at least K PRACH occasions may be realized within multiple association periods, that is, the number of association periods corresponding to PRACH repetitions may be more than one. In this case, N may be less than K, for example, N=K/L, where L is the number of association periods corresponding to PRACH repetitions.

In an embodiment, the N PRACH occasions include N PRACH occasions that are different in time domain, and difference in time domain herein means that the PRACH occasions are at different time-domain locations. Specifically, since PRACH occasions in which PRACH repetitions are located need to be PRACH occasions that are different in time domain, the association period may be further defined as the smallest multiple determined in a value range of the integer multiple of the PRACH configuration period, where the smallest multiple satisfies that each SSB transmitted by the network can be mapped to at least N PRACH occasions that are different in time domain, and N may be less than or equal to the number of PRACH repetitions.

In practice, whether each multiple of the PRACH configuration period satisfies the predefined condition may be determined according to the number N_{TX}^{SSB} of SSBs transmitted by the network, the number of SSBs mapped to each PRACH such as the foregoing parameter ssb-perRACH-Occasion, and the number of PRACH repetitions.

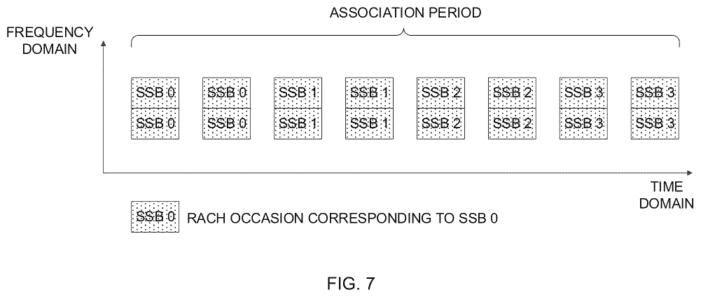

For example, if msg1-FDM=2 (the number of frequency-domain PRACH occasions is two), ssb-perRACH-Occasion=¼ (each SSB is mapped to four PRACH occasions), N_{TX}^{SSB}=4 (the number of SSBs actually transmitted is four), and each SSB is mapped at least once to a PRACH occasion within each association period, the association period between SSBs and PRACH occasions is that as illustrated in FIG. 7.

Assuming that the number of PRACH repetitions is two, each SSB needs to be mapped to at least two PRACH occasions different in time domain within each association period. In this case, the mapping between SSBs and PRACH occasions in FIG. 7 satisfies the requirement, and therefore, the size of the association period illustrated in FIG. 7 can be adopted.

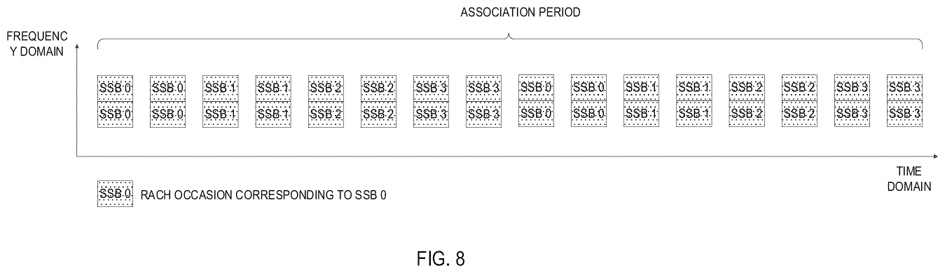

Assuming that the number of PRACH repetitions is four, each SSB needs to be mapped to at least four PRACH occasions different in time domain within each association period, and the size of the association period needs to be that as illustrated in FIG. 8.

Specifically, the association periods may be implemented as consecutive in time domain. For example, based on the size of the association period, multiple periods that are consecutive in time domain may be determined and taken as multiple association periods. A starting location of a 1st association period may be radio frame number 0, that is, the multiple consecutive association periods are determined starting from radio frame number 0.

As described above, the terminal device may map SSBs to at least K PRACH occasions within multiple association periods, that is, the number of association periods corresponding to PRACH repetitions may be more than one. In this case, the terminal device needs to determine the number of association periods corresponding to PRACH repetitions.

In an embodiment, the number of association periods corresponding to PRACH repetitions is determined according to the number of PRACH repetitions and the number of PRACH occasions that each SSB transmitted by the network device is mapped to within each association period. Accordingly, the terminal device determines the related information of the association period between PRACH occasions and SSBs according to the number of PRACH repetitions in step S110 as follows. The terminal device determines the number of association periods corresponding to PRACH repetitions according to the number of PRACH repetitions and the number of PRACH occasions that each SSB transmitted by the network device is mapped to within each association period.

In an embodiment, the number of PRACH occasions that each SSB is mapped to within the association period is specifically the number of PRACH occasions different in time domain that each SSB is mapped to within the association period.

Specifically, assume that each SSB is associated at least with one PRACH occasion within each association period. If a UE needs to determine K PRACH occasions, M association periods need to be determined, where M≤K, and the value of M depends on how many PRACH occasions different in time domain that each SSB is mapped to within each association period. For example, if the number of PRACH occasions that each SSB is mapped to within each association period is X, M may be K/X, where X is an integer and X≥1.

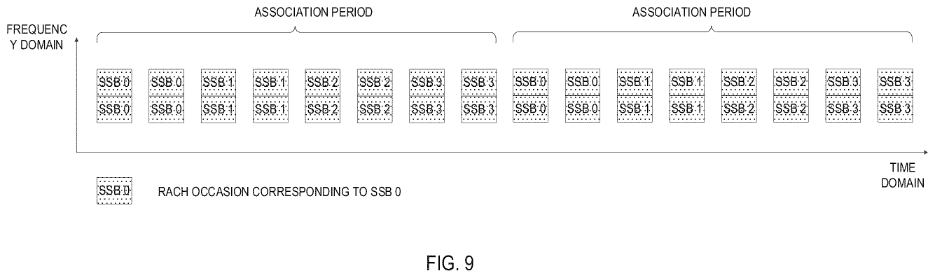

For example, assuming that the number of PRACH repetitions K=4, as illustrated in FIG. 9, each SSB is mapped to two PRACH occasions different in time domain within each association period, and accordingly, M=2, that is, there may be four PRACH occasions that are different in time domain and correspond to each SSB within the two association periods, and the UE may perform PRACH repetitions in the four PRACH occasions.

According to the above elaboration, PRACH repetitions can be implemented within one or more association periods, that is, PRACH repetitions may correspond to an association period set. A location of an association period set corresponding to PRACH repetitions is determined according to the number of association periods corresponding to PRACH repetitions. Specifically, the method for information processing may further include the following. The terminal device determines the location of the association period set corresponding to PRACH repetitions according to the number of association periods corresponding to the PRACH repetitions.

For example, if each association period set includes M association periods (namely, the number of association periods corresponding to PRACH repetitions is M), every M association periods may be used as one association period set starting from radio frame number 0 in time domain, to obtain a location of each association period set.

In an embodiment, the location of the association period set is determined according to the number of association periods corresponding to PRACH repetitions and a first parameter configured by the network device. Accordingly, the terminal device determines the location of the association period set corresponding to PRACH repetitions according to the number of association periods corresponding to PRACH repetitions as follows. The terminal device determines the location of the association period set according to the number of association periods corresponding to PRACH repetitions and the first parameter configured by the network device.

In an embodiment, the first parameter includes a time interval between adjacent association period sets, and/or an offset parameter corresponding to a starting location of the association period set.

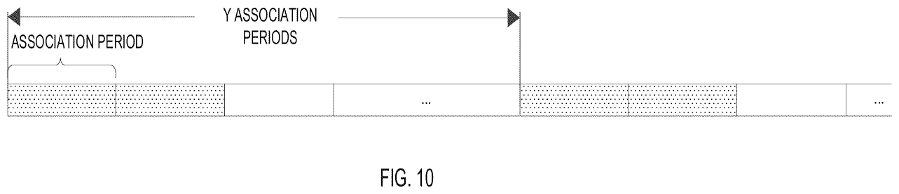

For example, as illustrated in FIG. 10, the network may configure an interval Y between association period sets, that is, an interval between two adjacent association period sets is Y association periods. In this case, a starting location of every Y association periods may be determined starting from radio frame number 0 in time domain and used as a starting location of each association period set, and an ending location of each association period set may be determined according to the number M of association periods corresponding to PRACH repetitions.

For another example, the network may configure a radio frame offset parameter. A starting location of each association period set or of every Y association periods may be determined according to the radio frame offset parameter, and then a location of each association period set may be obtained through division in time domain starting from the starting location of each association period set or of every Y association periods according to the number of association periods in each association period set or the time interval described above.

Embodiments of the disclosure further provide a mechanism for preamble selection during PRACH repetitions within an association period(s) corresponding to PRACH repetitions. The association period corresponding to PRACH repetitions may be one or more association periods, that is, the association period set described above.

In an embodiment, the method for information processing further includes the following. The terminal device performs PRACH repetitions to the network device by using the same preamble in at least two PRACH occasions within the association period corresponding to PRACH repetitions.

Accordingly, for the network device, the preambles received from the terminal device or from the same terminal device in the at least two PRACH occasions are the same.

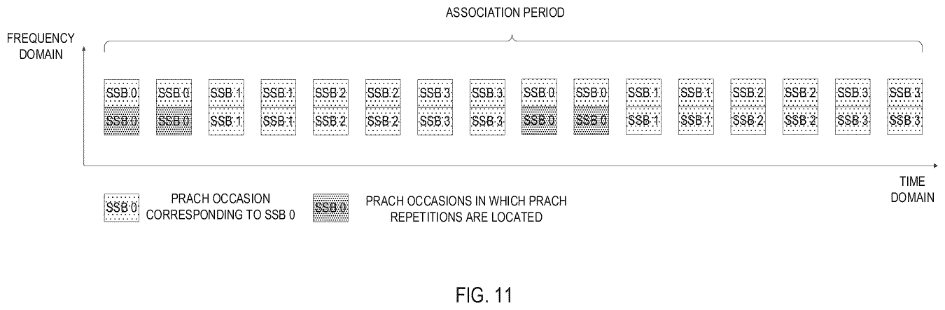

Specifically, the number of contention based preambles per SSB per valid PRACH occasion is indicated by a parameter CB-PreamblesPerSSB. During PRACH repetitions, the preambles used for PRACH transmissions in different PRACH occasions may be the same, which is beneficial for the network to detect the PRACH transmitted in PRACH repetitions and simplify resource allocation for PRACH repetitions. When initiating random access, the UE selects a PRACH occasion and a preamble corresponding to an SSB, and the preamble used in each PRACH occasion is the same during PRACH repetitions. As illustrated in FIG. 11, the association period has at least four PRACH occasions that are different in time domain and correspond to each SSB. Assuming that a target SSB is SSB 0, the UE may select the same preamble to perform PRACH transmission in four PRACH occasions corresponding to SSB 0.

In an embodiment, the method for information processing further includes the following. The terminal device performs PRACH repetitions to the network device by using at least two different preambles in at least two PRACH occasions within the association period corresponding to PRACH repetitions.

Accordingly, for the network device, the preambles received from the terminal device or from the same terminal device in the at least two PRACH occasions are different.

That is, during PRACH repetitions, preambles used for at least two transmissions in corresponding PRACH occasions are different. Specifically, the UE may select, from a preamble set corresponding to SSBs, different preambles that are to be used in different PRACH occasions within one or more association periods corresponding to PRACH repetitions.

In an embodiment, the at least two different preambles used by the terminal device in the at least two PRACH occasions (namely, the preambles received from the terminal device by the network device in the at least two PRACH occasions) have an association that is predefined or configured by the network device.

That is, preambles used in different PRACH occasions have an association, which is conducive for the network device to determine whether preambles received in different PRACH occasions correspond to the same PRACH that is transmitted in PRACH repetitions.

Exemplarily, the terminal device may select randomly one preamble from a preamble set corresponding to SSBs in a 1st PRACH occasion for PRACH repetitions, and determine preambles for PRACH repetitions in subsequent PRACH occasions according to an association between preambles in different PRACH occasions.

In an embodiment, the at least two different preambles used by the terminal device in the at least two PRACH occasions (namely, preambles received from the terminal device by the network device in the at least two PRACH occasions) correspond to at least two transmission powers respectively.

In an embodiment, the method for information processing further includes the following. The network device sends preamble indication information to the terminal device, where the preamble indication information indicates a first preamble determined by the network device from the at least two different preambles received in the at least two PRACH occasions, and the first preamble is used by the terminal device to determine a transmission power of a physical uplink shared channel (PUSCH).

Accordingly, for the terminal device, the method for information processing further includes the following. The terminal device determines the first preamble according to the preamble indication information received from the network device, and determines the transmission power of the PUSCH according to a transmission power corresponding to the first preamble.

Exemplarily, the preamble indication information indicates the first preamble, and the first preamble may be one of the at least two different preambles. In an embodiment, the preamble indication information may be carried in a random access response (RAR) sent by the network device, and accordingly, the transmission power of the PUSCH may be a transmission power of a message 3 (Msg3) PUSCH in a four-step random access procedure.

That is, the UE uses different preambles in different PRACH occasions, so that the network device such as a base station can indicate, via an RAR, a preamble detected by the network to the UE. Since different preambles transmitted on different PRACHs correspond to different transmission powers, the UE may determine a corresponding transmission power according to the preamble indicated by the network, and then determine a power of subsequent Msg3 transmission according to the transmission power.

The settings and implementations of embodiments of the disclosure are described above from different perspectives with reference to multiple embodiments. As can be seen, by means of the at least one embodiment described above, the related information of the association period between PRACH occasions and SSBs is determined according to the number of PRACH repetitions, so that a PRACH occasion(s) that each SSB transmitted by the network is mapped to within the association period satisfies requirements of PRACH repetitions, which is beneficial to improving coverage performance of a PRACH.

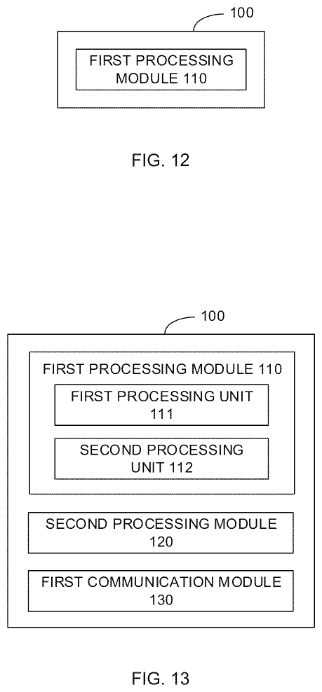

Corresponding to the processing method in at least one of the foregoing embodiments, embodiments of the disclosure further provide a terminal device 100. Referring to FIG. 12, the terminal device 100 includes a first processing module 110. The first processing module 110 is configured to determine related information of an association period between PRACH occasions and SSBs according to the number of PRACH repetitions.

In an embodiment, the related information of the association period includes a size of the association period, and/or the number of association periods corresponding to PRACH repetitions.

In an embodiment, in embodiments of the disclosure, as illustrated in FIG. 13, the first processing module 110 includes a first processing unit 111. The first processing unit 111 is configured to determine the size of the association period from at least one multiple of a PRACH configuration period according to the number of PRACH repetitions.

In an embodiment, the first processing unit 111 is specifically configured to determine the smallest value in the at least one multiple that satisfies a predefined condition as the size of the association period, where the predefined condition relates to the number of PRACH repetitions.

In an embodiment, the predefined condition includes: each SSB transmitted by a network device can be mapped to at least N PRACH occasions within a time domain window corresponding to the multiple, where N depends on the number of PRACH repetitions, and N is an integer and N≥1.

In an embodiment, the N PRACH occasions include N PRACH occasions that are different in time domain.

In an embodiment, as illustrated in FIG. 13, the first processing module 110 includes a second processing unit 112. The second processing unit 112 is configured to determine the number of association periods corresponding to PRACH repetitions according to the number of PRACH repetitions and the number of PRACH occasions that each SSB transmitted by the network device is mapped to within each association period.

In an embodiment, as illustrated in FIG. 13, the terminal device 100 further includes a second processing module 120. The second processing module 120 is configured to determine a location of an association period set corresponding to PRACH repetitions according to the number of association periods corresponding to PRACH repetitions.

In an embodiment, the second processing module 120 is specifically configured to determine the location of the association period set according to the number of association periods corresponding to PRACH repetitions and a first parameter configured by the network device.

In an embodiment, the first parameter includes a time interval between adjacent association period sets, and/or an offset parameter corresponding to a starting location of the association period set.

In an embodiment, in an implementation, as illustrated in FIG. 13, the terminal device 100 further includes a first communication module 130. The first communication module 130 is configured to perform PRACH repetitions to the network device by using the same preamble in at least two PRACH occasions within an association period corresponding to PRACH repetitions.

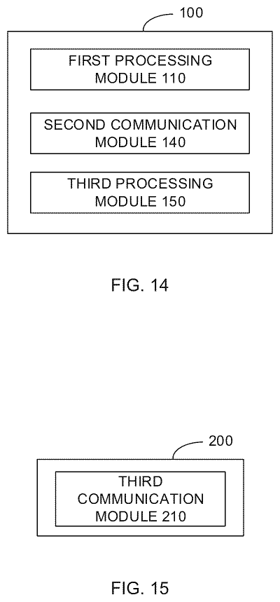

In an embodiment, in another implementation, as illustrated in FIG. 14, the terminal device 100 further includes a second communication module 140. The second communication module 140 is configured to perform PRACH repetitions to the network device by using at least two different preambles in at least two PRACH occasions within an association period corresponding to PRACH repetitions.

In an embodiment, the at least two different preambles have an association that is predefined or configured by the network device.

In an embodiment, the at least two different preambles correspond to at least two transmission power respectively.

In an embodiment, the terminal device 100 further includes a third processing module 150. The third processing module 150 is configured to determine a first preamble according to preamble indication information received from the network device, and determine a transmission power of a PUSCH according to a transmission power corresponding to the first preamble.

The terminal device 100 in embodiments of the disclosure can implement corresponding functions of the terminal device in the foregoing method embodiments. For the procedure, function, implementation, and advantage corresponding to each module (sub-module, unit, or assembly, etc.) in the terminal device 100, reference can be made to the corresponding illustrations in the foregoing method embodiments, which will not be described in detail again herein. It should be noted that, the functions of various modules (sub-modules, units, or assemblies, etc.) in the terminal device 100 described in embodiments of the disclosure may be implemented by different modules (sub-modules, units, or assemblies, etc.), or may be implemented by the same module (sub-module, unit, or assembly, etc.). For example, the first processing module and the second processing module may be different modules or may be the same module, both of which can implement the corresponding functions thereof in embodiments of the disclosure. In addition, the communication module in embodiments of the disclosure may be implemented by a transceiver of a device, and some or all of the other modules may be implemented by a processor of the device.

FIG. 15 is a schematic block diagram of a network device 200 according to an embodiment of the disclosure. The network device 200 may include a third communication module 210. The third communication module 210 is configured to send indication information of a PRACH resource to a terminal device, where the PRACH resource includes PRACH occasions for PRACH repetitions, and related information of an association period between PRACH occasion and SSBs is determined according to the number of PRACH repetitions.

In an embodiment, the related information of the association period comprises a size of the association period, and/or the number of association periods corresponding to PRACH repetitions.

In an embodiment, the size of the association period is determined from at least one multiple of a PRACH configuration period according to the number of PRACH repetitions.

In an embodiment, the size of the association period is the smallest value in the at least one multiple that satisfies a predefined condition, and the predefined condition relates to the number of PRACH repetitions.

In an embodiment, the predefined condition includes: each SSB transmitted by the network device can be mapped to at least N PRACH occasions within a time domain window corresponding to the multiple, where N depends on the number of PRACH repetitions, and N is an integer and N≥1.

In an embodiment, the N PRACH occasions include N PRACH occasions that are different in time domain.

In an embodiment, the number of association periods corresponding to PRACH repetitions is determined according to the number of PRACH repetitions and the number of PRACH occasions that each SSB transmitted by the network device is mapped to within each association period.

In an embodiment, a location of an association period set corresponding to PRACH repetitions is determined according to the number of association periods for PRACH repetitions.

In an embodiment, the location of the association period set is determined according to the number of association periods corresponding to PRACH repetitions and a first parameter configured by the network device.

In an embodiment, the first parameter comprises a time interval between adjacent association period sets, and/or an offset parameter corresponding to a starting location of the association period set.

In an embodiment, preambles received in at least two PRACH occasions within an association period corresponding to PRACH repetitions are the same.

In an embodiment, preambles received in at least two PRACH occasions within an association period corresponding to PRACH repetitions are different.

In an embodiment, the preambles received in the at least two PRACH occasions have an association that is predefined or configured by the network device.

In an embodiment, the preamble received in the at least two PRACH occasions correspond to at least two transmission power respectively.

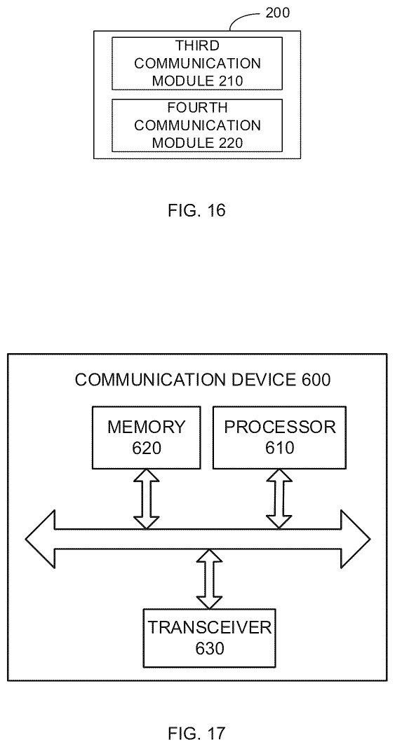

In an embodiment, as illustrated in FIG. 16, the network device 200 further includes a fourth communication module 220. The fourth communication module 220 is configured to send preamble indication information to the terminal device, where the preamble indication information indicates a first preamble determined by the network device from at least two different preambles received in at least two PRACH occasions, and the first preamble is used by the terminal device to determine a transmission power of a PUSCH.

The network device 200 in embodiments of the disclosure can implement corresponding functions of the terminal device in the foregoing method embodiments. For the procedure, function, implementation, and advantage corresponding to each module (sub-module, unit, or assembly, etc.) in the network device 200, reference can be made to the corresponding illustrations in the foregoing method embodiments, which will not be described in detail again herein. It should be noted that, the functions of various modules (sub-modules, units, or assemblies, etc.) in the network device 200 described in embodiments of the disclosure may be implemented by different modules (sub-modules, units, or assemblies, etc.), or may be implemented by the same module (sub-module, unit, or assembly, etc.). For example, the first processing module and the second processing module may be different modules or may be the same module, both of which can implement the corresponding functions thereof in embodiments of the disclosure. In addition, the communication module in embodiments of the disclosure may be implemented by a transceiver of a device, and some or all of the other modules may be implemented by a processor of the device.

FIG. 17 is a schematic structural diagram of a communication device 600 according to embodiments of the disclosure. The communication device 600 includes a processor 610. The processor 610 can invoke and execute computer programs stored in a memory, to implement the method in embodiments of the disclosure.

In an embodiment, as illustrated in FIG. 17, the communication device 600 may further include a memory 620, where the processor 610 can invoke and execute computer programs stored in the memory 620 to implement the method in embodiments of the disclosure.

The memory 620 may be a separate device independent of the processor 610, or may be integrated into the processor 610.

In an embodiment, as illustrated in FIG. 17, the communication device 600 may further include a transceiver 630. The processor 610 can control the transceiver 630 to communicate with other devices, and specifically, to send information or data to other devices or receive information or data sent by other devices.

The transceiver 630 may include a transmitter and a receiver. The transceiver 630 can further include an antenna, where one or more antennas may be provided.

In an embodiment, the communication device 600 may specifically be a network device in embodiments of the disclosure, and the communication device 600 may implement corresponding operations implemented by the network device in various methods in embodiments of the disclosure, which will not be described again herein for the sake of brevity.

In an embodiment, the communication device 600 may specifically be a terminal device in embodiments of the disclosure, and the communication device 600 may implement corresponding operations implemented by the terminal device in various methods in embodiments of the disclosure, which will not be described again herein for the sake of brevity.

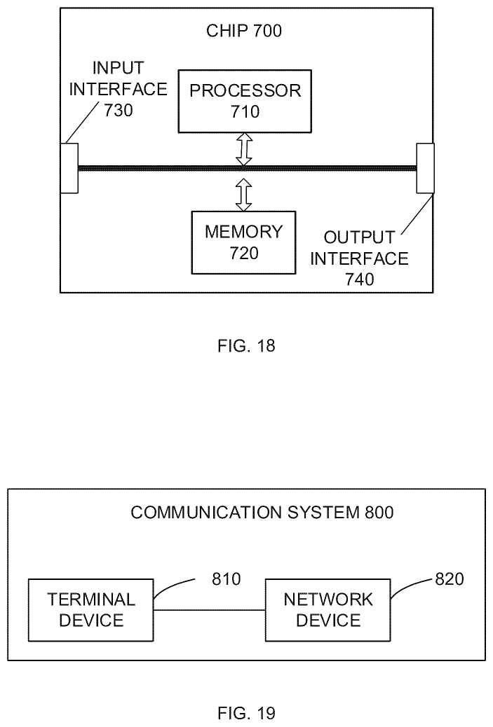

FIG. 18 is a schematic structural diagram of a chip according to embodiments of the disclosure. The chip 700 includes a processor 710. The processor 710 can invoke and execute computer programs stored in a memory, so as to implement the method in embodiments of the disclosure.

In an embodiment, as illustrated in FIG. 18, the chip 700 may further include a memory 720. The processor 710 can invoke and execute computer programs stored in the memory 720, so as to implement the method in embodiments of the disclosure.

The memory 720 may be a separate device independent of the processor 710, or may be integrated into the processor 710.

In an embodiment, the chip 700 may further include an input interface 730. The processor 710 can control the input interface 730 to communicate with other devices or chips, and specifically, to obtain information or data sent by other devices or chips.

In an embodiment, the chip 700 may further include an output interface 740. The processor 710 can control the output interface 740 to communicate with other devices or chips, and specifically, to output information or data to other devices or chips.

In an embodiment, the chip may be applied to the network device in embodiments of the disclosure, and the chip may implement corresponding operations implemented by the network device in various methods in embodiments of the disclosure, which will not be described again herein for the sake of brevity.

In an embodiment, the chip may be applied to the terminal device in embodiments of the disclosure, and the chip may implement corresponding operations implemented by the terminal device in various methods in embodiments of the disclosure, which will not be described again herein for the sake of brevity.

It should be understood that, the chip in embodiments of the disclosure may also be referred to as a system-on-chip (SOC).

The foregoing processor may be a general-purpose processor, a digital signal processor (DSP), a field programmable gate array (FPGA), an application specific integrated circuit (ASIC), or other programmable logic devices, transistor logic devices, discrete hardware components, etc. The general-purpose processor may be a microprocessor, or the processor may be any conventional processor or the like.

The memory in embodiments of the disclosure may be a volatile memory or a non-volatile memory, or may include both the volatile memory and the non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM).

It should be understood that, the memory above is intended for illustration rather than limitation. For example, the memory in embodiments of the disclosure may also be a static RAM (SRAM), a dynamic RAM (DRAM), a synchronous DRAM (SDRAM), a double data rate SDRAM (DDR SDRAM), a enhanced SDRAM (ESDRAM), a synch link DRAM (SLDRAM), a direct rambus RAM (DR RAM), etc. In other words, the memory in embodiments of the disclosure is intended to include, but is not limited to, these and any other suitable types of memory.

FIG. 19 is a schematic block diagram of a communication system 800 according to embodiments of the disclosure. The communication system 800 includes a terminal device 810 and a network device 820.

The terminal device 810 may be configured to implement corresponding functions implemented by the terminal device in the method in various embodiments of the disclosure, and the network device 820 may be configured to implement corresponding functions implemented by the network device in the method in various embodiments of the disclosure, which will not be described again herein.

All or some of the above embodiments can be implemented through software, hardware, firmware, or any other combination thereof. When implemented by software, all or some the above embodiments can be implemented in the form of a computer program product. The computer program product includes one or more computer instructions. When the computer instructions are applied and executed on a computer, all or some the operations or functions of the embodiments of the disclosure are performed. The computer can be a general-purpose computer, a special-purpose computer, a computer network, or other programmable apparatuses. The computer instruction can be stored in a non-transitory computer-readable storage medium, or transmitted from one non-transitory computer-readable storage medium to another non-transitory computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The non-transitory computer-readable storage medium can be any computer accessible usable-medium or a data storage device such as a server, a data center, or the like which integrates one or more usable media. The usable medium can be a magnetic medium (such as a soft disk, a hard disk, or a magnetic tape), an optical medium (such as a digital video disc (DVD)), or a semiconductor medium (such as a solid state disk (SSD)), etc.

It should be understood that, in various embodiments of the disclosure, the magnitude of a sequence number of each of the foregoing processes does not imply an execution order, and the execution order between the processes should be determined according to function and internal logic thereof, which shall not constitute any limitation to the implementation of embodiments of the disclosure.

It will be evident to those skilled in the art that, for the sake of convenience and brevity, in terms of the specific working processes of the foregoing systems, apparatuses, and units, reference can be made to the corresponding processes in the foregoing method embodiments, which will not be described in detail again herein.

In elaborations of the specification, elaborations with reference to terms “an embodiment”, “some embodiments”, “an example”, “a specific example”, or “some examples” mean that a particular feature, structure, material, or characteristic described in connection with the embodiment or example is included in at least one embodiment or example of the disclosure. In addition, the particular features, structures, materials, or characteristics described may be combined in any suitable manner in any one or more embodiments or examples. Furthermore, those skilled in the art can combine different embodiments or examples and features of different embodiments or examples described in the specification without conflicting with each other.

In addition, terms such as “first” and “second” are merely used for illustration and are not intended to indicate or imply relative importance or significance or to imply the number of indicated technical features. Thus, the features defined with “first” and “second” may explicitly or implicitly include at least one of the features. In elaborations of the disclosure, the meaning of “multiple” is two or more, unless specified otherwise.

The foregoing elaborations are merely implementations of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

I/We claim:

1. A method for information processing, comprising:
determining, by a terminal device, related information of an association period between physical random access channel (PRACH) occasions and synchronization signal/physical broadcast channel blocks (SS/PBCH blocks, SSBs) according to a number of PRACH repetitions.

2. The method of claim 1, wherein the related information of the association period comprises:
a size of the association period; and/or
the number of association periods corresponding to PRACH repetitions.

3. The method of claim 1, wherein determining, by the terminal device, the related information of the association period between PRACH occasions and SSBs according to the number of PRACH repetitions comprises:
determining, by the terminal device, a size of the association period from at least one multiple of a PRACH configuration period according to the number of PRACH repetitions.

4. The method of claim 3, wherein determining, by the terminal device, the size of the association period from the at least one multiple of the PRACH configuration period according to the number of PRACH repetitions comprises:
determining, by the terminal device, a smallest value in the at least one multiple that satisfies a predefined condition as the size of the association period, wherein the predefined condition relates to the number of PRACH repetitions.

5. The method of claim 4, wherein the predefined condition comprises:
each SSB transmitted by a network device can be mapped to at least N PRACH occasions within a time domain window corresponding to the multiple, wherein N depends on the number of PRACH repetitions, and N is an integer and N≥1.

6. The method of claim 5, wherein the N PRACH occasions comprise N PRACH occasions that are different in time domain.

7. The method of claim 1, wherein determining, by the terminal device, the related information of the association period between PRACH occasions and SSBs according to the number of PRACH repetitions comprises:
determining, by the terminal device, the number of association periods corresponding to PRACH repetitions according to the number of PRACH repetitions and the number of PRACH occasions that each SSB transmitted by a network device is mapped to within each association period.

8. The method of claim 1, further comprising:
determining, by the terminal device, a location of an association period set corresponding to PRACH repetitions according to the number of association periods corresponding to PRACH repetitions.

9. The method of claim 8, wherein determining, by the terminal device, the location of the association period set corresponding to PRACH repetitions according to the number of association periods corresponding to PRACH repetitions comprises:
determining, by the terminal device, the location of the association period set according to the number of association periods corresponding to PRACH repetitions and a first parameter configured by a network device.

10. The method of claim 9, wherein the first parameter comprises:
a time interval between adjacent association period sets, and/or an offset parameter corresponding to a starting location of the association period set.

11. The method of claim 1, further comprising:
performing, by the terminal device, PRACH repetitions to a network device by using a same preamble in at least two PRACH occasions within an association period corresponding to PRACH repetitions.

12. A method for information processing, comprising:
sending, by a network device, indication information of a physical random access channel (PRACH) resource to a terminal device, wherein the PRACH resource comprises PRACH occasions for PRACH repetitions, and related information of an association period between PRACH occasions and synchronization signal/physical broadcast channel blocks (SS/PBCH blocks, SSBs) is determined according to the number of PRACH repetitions.

13. The method of claim 12, wherein the related information of the association period comprises:
a size of the association period; and/or
the number of association periods corresponding to PRACH repetitions.

14. The method of claim 12, wherein the number of association periods corresponding to PRACH repetitions is determined according to the number of PRACH repetitions and the number of PRACH occasions that each SSB transmitted by the network device is mapped to within each association period.

15. The method of claim 12, wherein a location of an association period set corresponding to PRACH repetitions is determined according to the number of association periods corresponding to PRACH repetitions.

16. The method of claim 12, wherein preambles received from the terminal device by the network device in at least two PRACH occasions within an association period corresponding to PRACH repetitions are the same.

17. A terminal device, comprising:
a memory configured to store computer programs; and
a processor configured to execute the computer programs stored in the memory, to determine related information of an association period between physical random access channel (PRACH) occasions and synchronization signal/physical broadcast channel blocks (SS/PBCH blocks, SSBs) according to a number of PRACH repetitions.

18. The terminal device of claim 17, wherein the related information of the association period comprises:
a size of the association period; and/or
the number of association periods corresponding to PRACH repetitions.

19. The terminal device of claim 17, wherein in terms of determining the related information of the association period between PRACH occasions and SSBs according to the number of PRACH repetitions, the processor is configured to execute the computer programs stored in the memory to:
determine the number of association periods corresponding to PRACH repetitions according to the number of PRACH repetitions and the number of PRACH occasions that each SSB transmitted by a network device is mapped to within each association period.

20. The terminal device of claim 17, wherein the processor is further configured to execute the computer programs stored in the memory to:
determine a location of an association period set corresponding to PRACH repetitions according to the number of association periods corresponding to PRACH repetitions.
